(19) United States
(12) Patent Application Publication
(10) Pub. No.: US 2006/0270371 A1
(43) Pub. Date: Nov. 30, 2006

(54) Tracking short-term maximum power spectrum density for improved visibility of low duty cycle signals

(76) Inventor: Gary L. Sugar, Bethesda, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/430,014

(22) Filed: May 9, 2006

Related U.S. Application Data
(60) Provisional application No. 60/685,544, filed on May 31, 2005.

(51) Int. Cl. H04B 17/00

(52) U.S. Cl. 455/226.1

(57) ABSTRACT

A method is provided for analyzing activity in a frequency band that improves over conventional spectrum analyzers by providing the ability to visualize signals or energy with short duty cycles. During a time interval, a sequence of short-time power spectrum estimates is computed for energy received in said frequency band. Each short-time power spectrum estimate comprises data representing power of the received energy at each of a plurality of frequency bins that span a frequency sub-band at different time instants during the time interval. Data associated with the sequence of power spectrum estimates is accumulated. This process is repeated for each of a plurality of different sub-bands that span a frequency band of interest. As a result, activity can be observed in the frequency band of interest over relatively short time intervals, even if the activity has a short duty cycle.

### RELATED APPLICATIONS

This application claims priority to U.S. Provisional Application No. 60/685,544, filed May 31, 2005, the entirety of which is incorporated herein by reference.

### BACKGROUND OF THE INVENTION

Spectrum analyzer devices are used to monitor radio frequency activity occurring in a frequency band of interest. A user wishing to learn about the types and patterns of activity in a particular locale must activate the spectrum analyzer and make various adjustments to the in order to begin seeing traces of data representing activity. Prior swept and Fast Fourier Transform (FFT) spectrum analyzers produce what is called a “normal” trace by sweeping across a frequency band and displaying parameters such as average power and max-hold that are derived from the sweeps as shown in FIG. 1. The swept analyzer sweeps across the band during a time interval thereby only detecting activity at a particular frequency if that activity exists at the instant the spectrum analyzer center frequency is at that particular frequency. Similarly, the FFT analyzer takes a single FFT spanning a frequency suboko0i-band, followed by a single FFT spanning another frequency sub-band, and so on. However, because these analyzers sweep across a frequency band of interest, it may miss detection of RF energy associated with signals that have very short duty cycles. For example, spectrum analyzers have become useful to IT administrators that are responsible for maintaining wireless local area networks (WLAN) used in business/enterprise environments. When an IT administrator uses a conventional spectrum analyzer to monitor activity, data associated with the signals from WLAN and other devices that share the frequency band with the WLAN devices will not be evident on the spectrum analyzer for a period of time, even though there is signal activity occurring. For example, short duty cycle signals such as IEEE 802.11 WLAN signals, Bluetooth™ signals, cordless phone signals, etc., all have relatively short duty cycles. Over a given time interval, these signals are ON very small amounts of time. Consequently, an IT administrator or other RF expert will have to spend a significant amount of time observing the spectrum analyzer plots in order to gain an understanding of what is occurring in the frequency band and locale of interest.

There is significant room for improving spectrum analyzers and the traces that they produce.

### SUMMARY OF THE INVENTION

Briefly, a method is provided for analyzing activity in a frequency band that improves over conventional spectrum analyzers by providing the ability to visualize signals or energy with short duty cycles. During a time interval, a sequence of short-time power spectrum estimates is computed for energy received in said frequency band. Each short-time power spectrum estimate comprises data representing power of the received energy at each of a plurality of frequency bins that span a frequency sub-band at different time instants during the time interval. Data associated with the sequence of power spectrum estimates is accumulated. This process is repeated for each of a plurality of different sub-bands that span a frequency band of interest. As a result, activity can be observed in the frequency band of interest over relatively short time intervals, even if the activity has a short duty cycle.

The objects and advantages of the techniques described herein will become more readily apparent when reference is made to following description taken in conjunction with the accompanying drawings.

### BRIEF DESCRIPTION OF THE DRAWINGS

FIG. 1 is a diagram showing operation of a conventional spectrum analyzer.

FIG. 2 is block diagram of a radio device useful in connection with the embodiments described herein.

FIG. 3 is diagram depicting exemplary signals that may be occurring in a shared, e.g., unlicensed frequency band.

FIGS. 4 and 5 are pictorial diagrams depicting the maximum power tracking technique according to embodiments of the present invention.

FIG. 6 is a flow chart depicting the maximum power tracking technique according to an embodiment according to an embodiment of the present invention.

FIGS. 7 and 8 are screen shots of actual plots for a maximum power trace, compared with plots for average power and max-hold traces produced according to embodiments of the present invention.

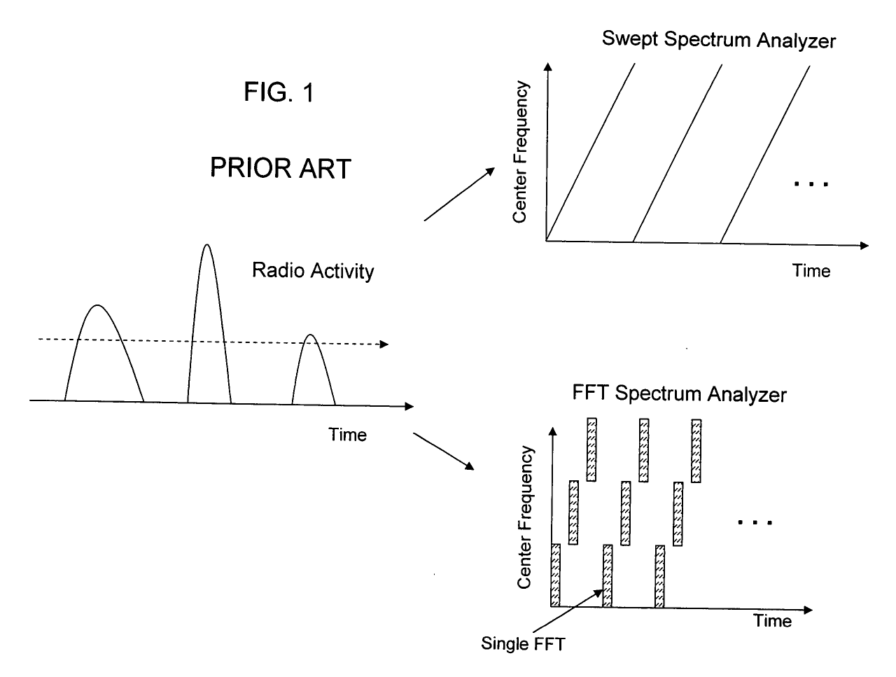

### DETAILED DESCRIPTION

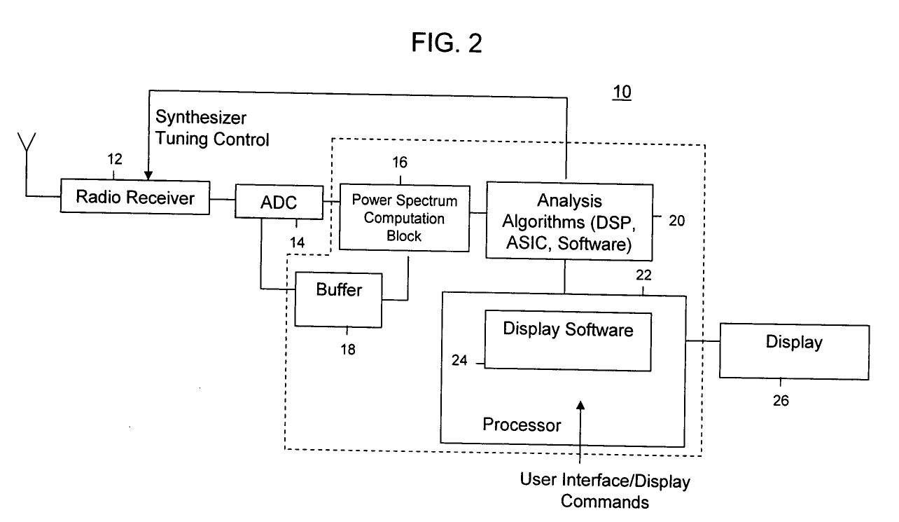

FIG. 2 shows an exemplary block diagram of a radio device 10 according to an embodiment of the invention. The radio device 10 comprises a radio receiver 12 that downconverts radio frequency (RF) energy detected by an antenna. The downconverted energy is then converted to digital signals by an analog-to-digital converter (ADC) 14. The digital signals are stored in a buffer 18. A power spectrum computation block 16 executes power spectrum computations on the digital data produced by the ADC 14 in order to produce short-time power spectrum estimates for energy received in said frequency band. Each short-time power spectrum estimate comprises data representing power of the received energy at each of a plurality of frequency bins that span a frequency sub-band. The power spectrum computation block 16 may produce the short-time power spectrum estimates by performing a short-time Fast Fourier Transform (FFT). However, it should be understood that there are ways, other than an FFT, of computing a short-time frequency transform to produce a measure of the power or strength of energy at each of a plurality of frequency bins that may be used according to the embodiments of the present invention; an FFT is only one example. In general, any device or process that can produce power spectrum data comprising data representing power or signal strength at a plurality of frequency bins is suitable. The functionality of the power spectrum computation block 16 may be performed by hardware (e.g. a dedicated application specific integrated circuit (ASIC), a digital signal processor (DSP) programmed with firmware or a general processor programmed with software.

The short-time Fourier transform (STFT) is a term known in the art to represent a Fourier transform taken on each of a plurality of time segments of a signal. It should be understood that the sequence of short-time power spectrum estimates need not be contiguous. The estimates may be decimated such that, for example, every other, every third, etc., of the short-time estimates are discarded. In addition, the power spectrum estimates may partially overlap, or not. Further still, the power spectrum estimates may subjected to a windowing function.

The power spectrum data output by the power spectrum computation block 16 is analyzed by analysis algorithms shown at reference numeral 20 that may be implemented in hardware (e.g., an application specific integrated circuit), digital signal processor (DSP) instructions or software. Display software 24 executed by a processor 22 generates data for display to a user on a display device 26. The display software 24 may respond to user interface or display commands that determine how and what type of data is displayed. For example, the display software 24 may generate plots of traces based on data derived from the maximum power tracking techniques according to the embodiments described herein.

FIG. 2 further shows by the dotted line around the processor 22, analysis algorithms 20, a power spectrum computation circuit 16 and memory buffer 18 is meant to indicate that, according to one embodiment, all of these functions may be performed by a processor (microprocessor, microcontroller, etc.) that is programmed with instructions stored in memory that, when executed, cause the processor to perform the various functions described herein.

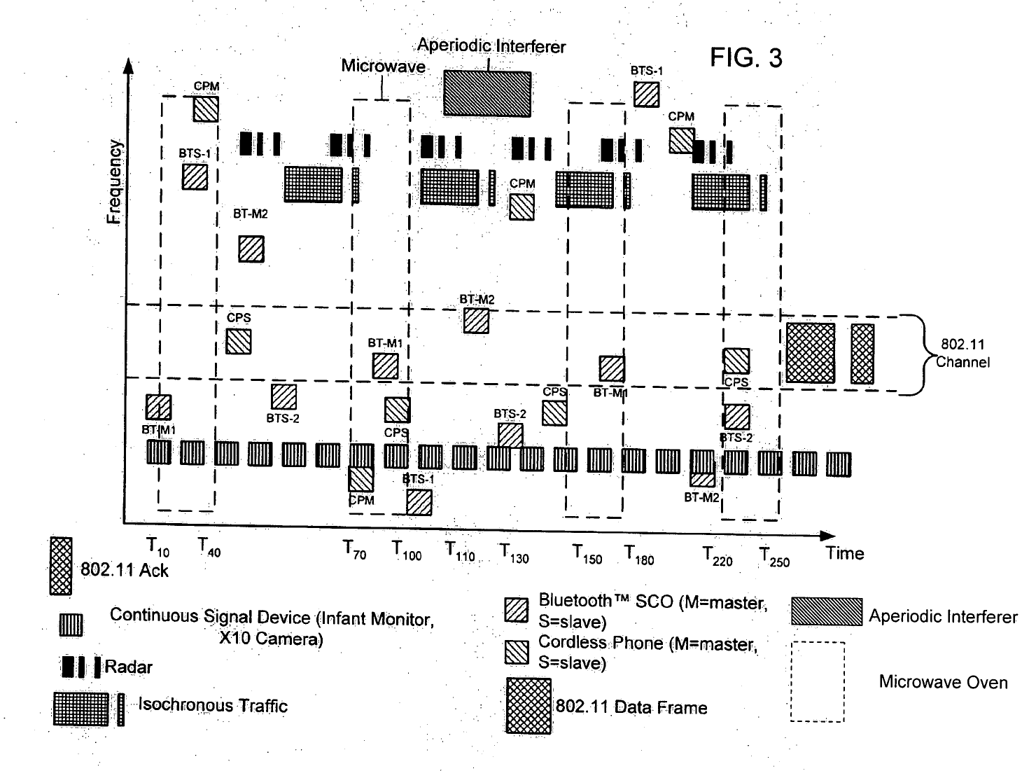

FIG. 3 pictorially represents examples of signals occurring in a shared, e.g., unlicensed, radio frequency band according to an embodiment. A legend is shown for the various signal pulses shown. It is in this sort of RF environment where the signal discrimination techniques according to the embodiments described herein are useful, but it is to be understood that these techniques are useful in other RF environments.

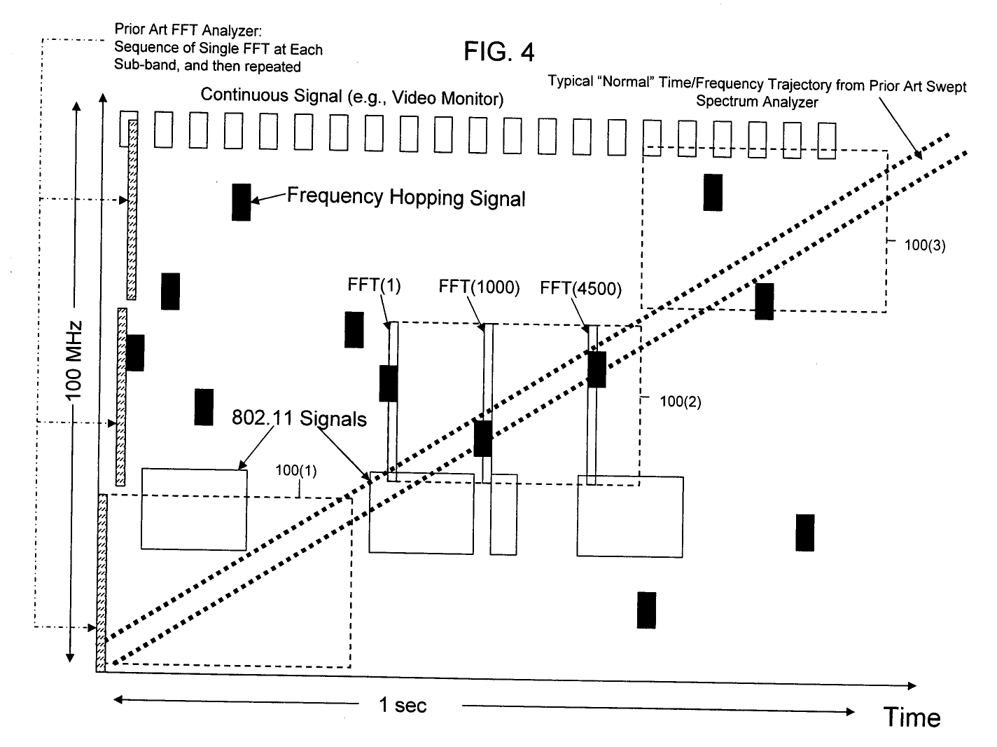

Turning now to FIGS. 4-6, the maximum power tracking and trace generation technique will be described. There are multiple FFT intervals, also called sampling time intervals. During each sampling time interval, a portion of a frequency band of interest is subjected to a sequence of short-time frequency transforms to produce a sequence of short-time power spectrum estimates. For example, as shown in FIG. 4, for a 100 MHz wide frequency band (e.g., the 2.4 to 2.5 GHz unlicensed band), there are three sampling intervals of approximately 33 MHz shown at reference numerals 100(1), 100(2) and 100(3). The dotted blocks shown in FIG. 4 indicate the time duration and frequency range associated with each of three sampling intervals. Again, each sampling interval consists of numerous short-time frequency transforms cycles, such as 5000 FFT cycles, for example. During each FFT cycle, a measure of the energy or power present in each of a certain number of frequency bins, for example 256 bins (f=256), is obtained. FIG. 4 illustrates that sampling interval 100(2) comprises FFT intervals FFT(1) to FFT(5000) according to one embodiment.

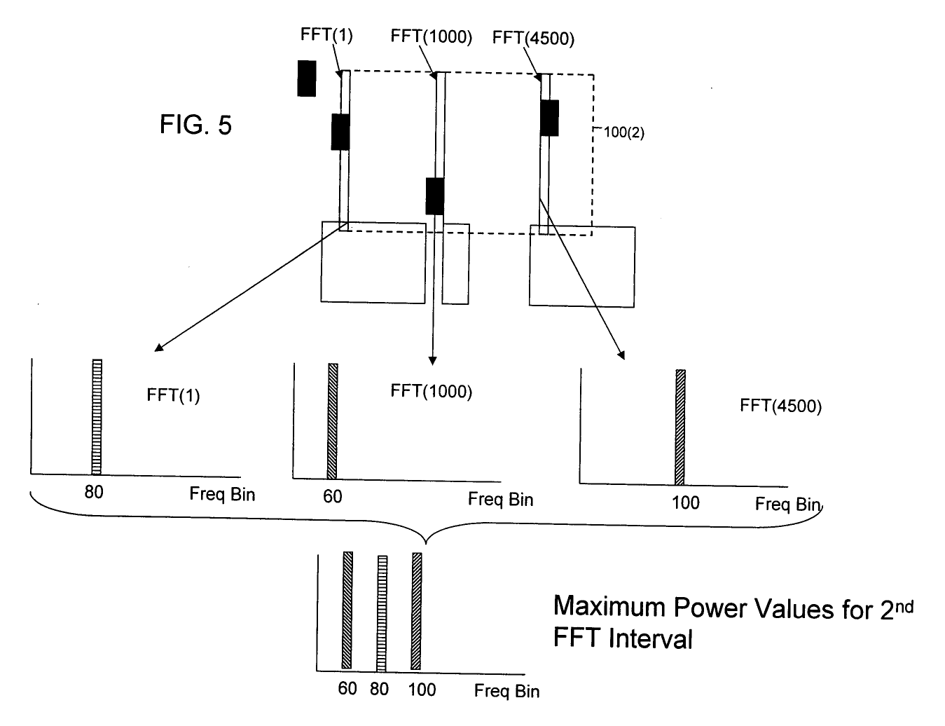

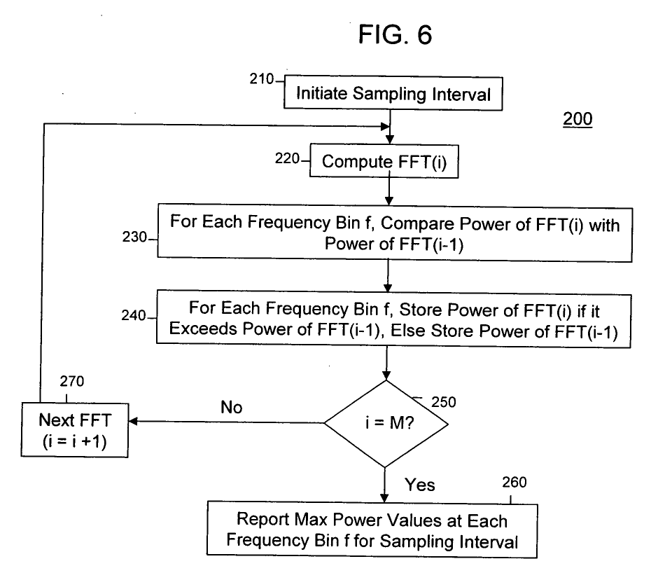

Reference is now made to FIGS. 5 and 6 for a more detailed description of the maximum power tracking technique according to an embodiment. The maximum power tracking computation procedure is shown at 200 in FIG. 5. At 210, a sampling time interval is initiated. During a sampling time interval, a plurality of FFT cycles are executed to produce a sequence of short-time power spectrum estimates associated therewith, wherein each FFT cycle produces a single block of short-time power spectrum estimate data at a time instant during said sampling time interval. At 220, the FFT cycle, FFT(i), is computed to produce power values at each of the frequency bins f for the FFT cycle. Next, at 230, the power value at each frequency bin for the current FFT cycle, FFT(i), is compared with the power value at that bin for the prior FFT cycle, FFT(i-l). At 240, if the power value at the bin for the current FFT cycle is greater than the power at that frequency bin for the prior FFT cycle, then the power value for the current FFT cycle at that bin is stored; otherwise the power value at that frequency for the prior FFT cycle is stored. This process is performed across all frequency bins from one FFT cycle to the next until the entire sampling interval is completed as depicted by 250 and 270. Then, at 260, the power value for each frequency bin is the maximum power value that occurred during the sampling interval. To summarize, the process 200 ultimately produces for each frequency bin associated with the power spectrum data, storing a value representing the maximum power that has occurred in each frequency bin in a sequence of short-time power spectrum estimate data produced over a sampling time interval. FIG. 6 shows the maximum power values that would be stored for the second sampling interval 100(2) shown in FIG. 4 according to one embodiment.

The process 200 shown in FIG. 6 is repeated for each sampling interval across a frequency range (i.e., channel) of the frequency band of interest to produce data that can be plotted over time for each of the frequency ranges of the frequency band. A trace is formed by extending the maximum power data for the previous sampling interval of a particular frequency range with data generated for the current sampling interval of that frequency range. A significant advantage of tracking maximum power in this manner is that the trace that can be plotted from this data over time is more informative because it inevitably changes along with real-time changes in the activity. By contrast, the “normal” trace produced by a conventional swept spectrum analyzer is capable of detecting and displaying only narrow portions of the RF spectrum occurring over the same time interval. The dashed diagonal lines extending from the lower left to the upper right in FIG. 4 are meant to indicate how a conventional swept spectrum analyzer generates this so called “normal” trace.

Moreover, the normal trace may be generated by a conventional FFT-based spectrum analyzer where a single FFT is taken spanning one frequency sub-band, a next single FFT is taken spanning another frequency sub-band, and so on. A plurality of these frequency sub-bands may span a frequency band of interest. The frequency sub-bands may, in one embodiment, be substantially contiguous across the frequency band. This is also shown in FIG. 4. A max-hold or normal trace is produced over time, but as can be seen in FIG. 4, conventional FFT-based spectrum analyzer techniques cannot detect and capture short-term changes, i.e., signals for very short duty cycles. By contrast, the improved technique as shown in an embodiment of FIG. 4 involves taking numerous, e.g., thousands of short-time FFTs in real-time (i.e., one N-point FFT is generated every N input samples) during a time interval covering a sub-band, i.e., a portion of the frequency band of interest, moving to a next sub-band and repeating the same. The maximum power value at each frequency bin over the plurality of FFTs taken during an FFT interval is determined, stored and displayed. As a result, RF energy activity with very short duty cycles is detected.

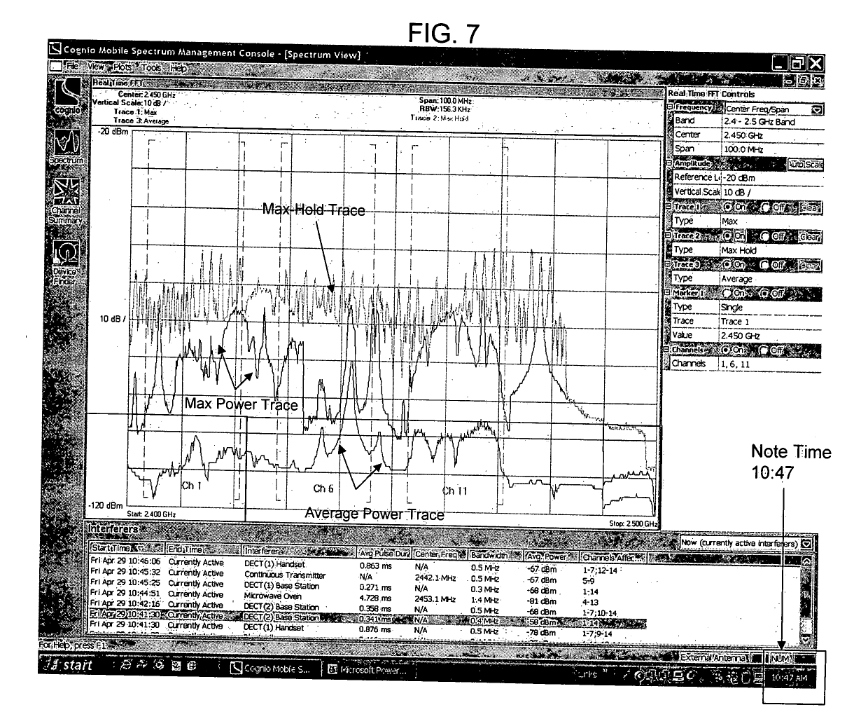

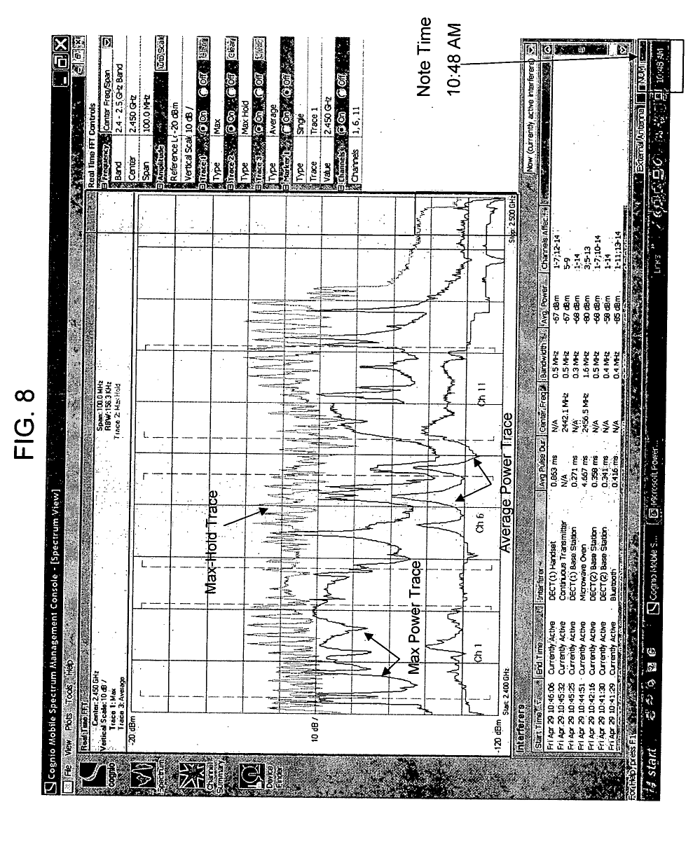

Turning to FIGS. 7 and 8, an example of the maximum power trace is described according to one embodiment. FIG. 7 shows traces for the maximum power produced as described above, and traces for average power and max-hold across three 802.11 channels (Chs. 1, 6 and 11) as of a particular time instance, 10:47 AM. FIG. 8 illustrates similar traces as of a time instant one minute later, 10:48 AM. What is very evident from these plots is that the average power and max-hold traces do not change significantly from one instant to the next, whereas the maximum power trace produced according to the embodiments described herein shows significant change. This is the advantage of the maximum power trace, but the techniques of the embodiments described herein are not limited to tracking changes in this type of environment; they are just as applicable to any type of RF monitoring application. The maximum power statistic and corresponding trace shows activity and changes in activity in the frequency band much more rapidly than current spectrum analyzer traces such as average power and max-hold. This is particularly helpful to an RF technician or IT administrator who is evaluating RF conditions of a particular locality.

The techniques described herein are particularly helpful when monitoring activity associated in a frequency band where activity associated with a wireless local area network (WLAN), such as an IEEE 802.11 WLAN, is also occurring. The duty cycle of RF activity in this particular wireless environment for any given channel is actually very low. The wide variety of IEEE 802.11 and other communication protocol signals from devices that come up and transmit data and acknowledgments occurs in relatively short RF energy bursts or packets. As a result, whereas a swept spectrum analyzer may miss such energy bursts and as a result require a much longer period of time before detecting them, the maximum power tracking approach described herein will detect and be capable of displaying data representative of such short and sporadic bursts nearly instantly (to the human eye) and nevertheless over a much shorter time window.

While the techniques have been described in connection with a self-contained radio device, it should be understood that the measurements may be made with a radio device, and the data further processed on another device (connected by a wired or wireless link) where the maximum power trace is generated and displayed to a user.

The system and methods described herein may be embodied in other specific forms without departing from the spirit or essential characteristics thereof. The foregoing embodiments are therefore to be considered in all respects illustrative and not meant to be limiting.

What is claimed is:

1. A method for analyzing wireless activity in a frequency band, comprising:
a. during a time interval, computing a sequence of short-time power spectrum estimates for energy received in said frequency band, each short-time power spectrum estimate comprising data representing power of the received energy at each of a plurality of frequency bins that span a frequency sub-band at different time instants during said time interval; and
b. accumulating data associated with said sequence of power spectrum estimates.

2. The method of claim 1, wherein (a) computing comprises computing a sequence of a plurality of short-time frequency transforms for energy received in said frequency band, each short-time frequency transform spanning said frequency sub-band but taken at said different time instants to produce said short-time power spectrum estimate.

3. The method of claim 1, and further comprising, for each frequency bin associated with the short-time power spectrum estimates, storing a value representing the maximum power that has occurred in each frequency bin in said sequence.

4. The method of claim 1, and further comprising generating data for displaying a trace representing the power values for each frequency bin over time.

5. The method of claim 1, and further comprising performing (a) computing during each of a plurality of time intervals, wherein the sequence of short-time power spectrum estimates during a time interval spans the same frequency sub-band, but the frequency sub-band is different across the plurality of time intervals.

6. The method of claim 5, wherein (a) computing comprises computing the sequence of short-time power spectrum estimates during the plurality of time intervals across the plurality of frequency sub-bands which are substantially contiguous and span a frequency band of interest.

7. The method of claim 5, wherein (b) accumulating comprises accumulating data associated with each of the sequences of short-time power spectrum estimates during each of the plurality of time intervals.

8. The method of claim 7, and further comprising, for each time interval, storing a value representing the maximum power that has occurred in each frequency bin over the sequence of short-time power spectrum estimates during that time interval.

9. The method of claim 8, and further comprising generating data for displaying a trace representing the power values for each frequency bin over time.

10. The method of claim 1, wherein said (a) computing comprises computing a sequence of short-time Fourier transforms.

11. The method of claim 1, wherein said (a) computing further comprises discarding some of the short-time power spectrum estimates.

12. The method of claim 1, wherein said (a) computing comprises computing said sequence of short-time power spectrum estimates such that they at least partially overlap in time.

13. A device, comprising:
a. a radio receiver that receives wireless energy in a frequency band and produces a receive signal representative thereof;
b. an analog-to-digital converter coupled to the radio receiver that converts the receive signal to digital data;
c. a power spectrum computation circuit coupled to the analog-to-digital converter that computes short-time power spectrum estimates for energy received in said frequency band from the digital data; and
d. a control unit connected to said power spectrum computation circuit and to said radio receiver, wherein the control unit controls the power spectrum computation circuit to compute a sequence of short-time power spectrum estimates for energy received in said frequency band, each short-time power spectrum estimate comprising data representing power of the received energy at each of a plurality of frequency bins that span a frequency sub-band at different time instants during said time interval.

14. The device of claim 13, wherein said power spectrum computation circuit computes short-time frequency transforms for energy in said frequency sub-band of said frequency band, each short-time frequency transform spanning said frequency sub-band but taken at said different time instants to produce said short-time power spectrum estimate.

15. The device of claim 13, wherein said control unit stores, for each frequency bin associated with the short-time power spectra estimates, data representing the maximum power that has occurred in that frequency bin in said sequence.

16. The device of claim 13, wherein said control unit controls the power spectrum computation circuit to compute the sequence of short-time power spectrum estimates during each of a plurality of time intervals, wherein the sequence of short-time power spectrum data during a time interval spans the same frequency sub-band, but the frequency sub-band is different across the plurality of time intervals.

17. The device of claim 13, wherein said control unit controls the power spectrum computation circuit to compute the sequence of short-time power spectrum estimates during the plurality of time intervals across the plurality of frequency sub-bands which are substantially contiguous and span a frequency band of interest.

18. The device of claim 17, wherein said control unit stores data associated with each of the sequences of short-time power spectrum estimates during each of the plurality of time intervals.

19. The device of claim 18, wherein said control unit stores, for each time interval, data representing the maximum power that has occurred in each frequency bin over the sequence of short-time power spectrum estimates during that time interval.

20. The device of claim 13, wherein said power spectrum computation circuit computes short-time Fourier transforms to produce said short-time power spectrum estimates.

21. A processor readable medium storing instructions, that when executed by a processor, cause the processor to perform functions of:
a. during a time interval, computing a sequence of short-time power spectrum estimates for energy received in said frequency band, each short-time power spectrum estimate comprising data representing power of the received energy at each of a plurality of frequency bins that span a frequency sub-band at different time instants during said time interval; and
b. accumulating data associated with the sequence of power spectrum estimates.

22. The processor readable medium of claim 21, and further comprising instructions that, when executed by a processor, cause the processor to, for each frequency bin associated with the sequence of short-time power spectrum estimates, store a value representing the maximum power that has occurred in each frequency bin in said sequence.

23. The processor readable medium of claim 22, and further comprising instructions that, when executed by a processor, cause the processor to generate data for displaying a trace representing the values for each frequency bin over time.

24. The processor readable medium of claim 21, wherein said instructions for computing comprise instructions that cause the processor to compute the sequence of short-time power spectrum estimates during each of a plurality of time intervals, wherein the sequence of short-time power spectrum estimates during a time interval spans the same frequency sub-band, but the frequency sub-band is different across the plurality of time intervals.

25. The processor readable medium of claim 24, wherein said instructions for computing comprise instructions that cause the processor to compute the sequence of short-time power spectrum estimates during the plurality of time intervals across the plurality of frequency sub-bands which are substantially contiguous and span a frequency band of interest.

26. The processor readable medium of claim 25, and further comprising instructions, that when executed by the processor, cause the processor to store a value representing the maximum power that has occurred in each frequency bin over during each of the plurality of time intervals.

27. The processor readable medium of claim 26, and further comprising instructions, that when executed by the processor, cause the processor to generate data for displaying a trace over time representing the maximum power at each frequency bin.

28. The processor readable medium of claim 21, wherein said instructions for computing comprise instructions that cause the processor to compute a sequence of short-time Fourier transforms.

29. The processor readable medium of claim 21, wherein said instructions for computing comprise instructions that cause the processor to discard some of the short-time power spectrum estimates.

30. processor readable medium of claim 21, wherein said instructions for computing comprise instructions that cause the processor to compute the sequence of short-time power spectrum estimates such that they at least partially overlap in time.
